(19) United States
(12) Patent Application Publication
(10) Pub. No.: US 2004/0083360 A1
(43) Pub. Date: Apr. 29, 2004

(54) System and method for partially-encrypted data transmission and reception

(76) Inventors: Rod Walsh, Tampere (FI); Dominique Muller, Helsinki (FI); Juha-Pekka Luoma, Tampere (FI)

Correspondence Address: MORGAN & FINNEGAN, L.L.P., 345 Park Avenue, New York, NY, 10154-0053, US

(21) Appl. No.: 10/281,507

(22) Filed: Oct. 28, 2002

(51) Int. Cl. H04L 9/00

(52) U.S. Cl. 713/160

(57) ABSTRACT

Systems and methods wherein a data entity is dispatched as a series of packets, with some of the packets being dispatched in an encrypted manner and others of the packets being dispatched in an unencrypted manner.

### FIELD OF INVENTION

This invention relates to systems and methods for data distribution.

### BACKGROUND INFORMATION

In recent years, there has been an increase in the use of wired and wireless networks for the transmission and reception of content and/or other data. Such content and/or other data can include, for example, messages, video, audio, and software.

It may be desirable to perform such transmissions in a manner that seeks to prevent the use of such content and/or other data by unintended recipients. Such may be the case for a number of reasons. For example, the content and/or other data could be of a confidential nature. As another example, a content provider could be charging a fee for use of the content and/or other data.

In light of this, there may be interest in technologies that facilitate preventing the use of transmissions by unintended recipients.

### SUMMARY OF THE INVENTION

According to embodiments of the present invention, there are provided systems and methods wherein a data entity is dispatched as a series of packets, with some of the packets being dispatched in an encrypted manner and others of the packets being dispatched in an unencrypted manner.

Such behavior could result in less computational overhead at sending and receiving nodes, while still providing a level of security for transmissions.

### BRIEF DESCRIPTION OF THE DRAWINGS

FIG. 1a shows an exemplary network topology corresponding to a unicast embodiment of the present invention.

FIG. 1a shows an exemplary network topology corresponding to a multicast embodiment of the present invention.

FIG. 2 is a flowchart showing exemplary steps preformed in packet reception in accordance with various embodiments of the present invention.

FIG. 3a is a diagram showing a pattern, based on an arithmetic progression, for stipulating packets to be dispatched in an encrypted manner.

FIG. 3b is a diagram showing a pattern, based on an extended arithmetic progression, for stipulating packets to be dispatched in an encrypted manner.

FIG. 3c is a diagram showing a pattern, based on a pseudo-Gaussian pattern, for stipulating packets to be dispatched in an encrypted manner.

FIG. 3d is a diagram showing a pattern, based on a random pattern, for stipulating packets to be dispatched in an encrypted manner.

FIG. 4a is a diagram showing an exemplary non-interleaved forward error correction implementation.

FIG. 4b is a diagram showing an exemplary interleaved forward error correction implementation.

FIG. 5 shows an exemplary general purpose computer employable in various embodiments of the present invention.

FIG. 6 shows a functional block diagram of an exemplary terminal employable in various embodiments of the present invention.

### DETAILED DESCRIPTION OF THE INVENTION

General Operation

According to embodiments of the present invention, there are provided systems and methods wherein a data entity is dispatched as a series of packets with some of the packets being dispatched in an encrypted manner and others of the packets being dispatched in an unencrypted manner. A data entity could be, for instance, streaming audio or video, non-streaming audio or video, a message, software, text, informational content, or a data file. As less decryption would need to be performed, such operation could result in the receipt of the data at a terminal requiring less processing power than would be necessary if all packets were encrypted. Similarly, as less encryption would need to be performed by a transmitting node, such operation could result in less processing power being required at the transmitting node than would be necessary if all packets were encrypted. Still, because a number of the packets would be encrypted, a level of security would be provided. The decision as to which of the packets would be dispatched in an encrypted manner and which of the packets would be dispatched in an unencrypted manner could, as will be described below, take a number of factors into account.

The above-noted lower requirements for processing power could result in less energy use by transmitting and/or receiving nodes. Such could be useful, for instance, for mobile nodes where less energy use could translate into longer battery life. Such could also be useful in applications where it is desired that equipment produce less heat. It is further noted that the lower requirement for processing power could also allow cheaper, less capable, and/or more energy efficient processors to be employed in nodes for data receipt and/or transmission.

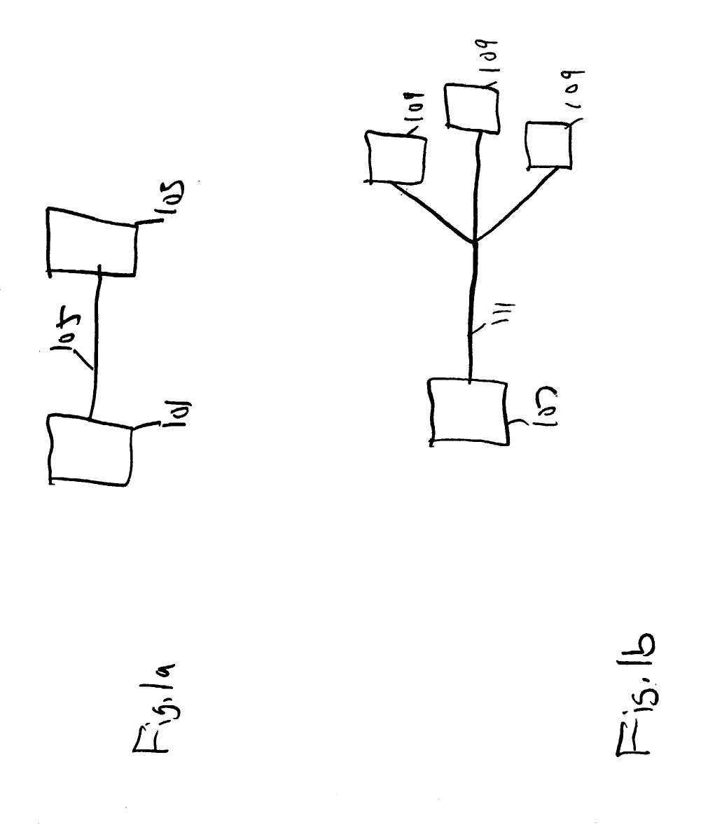

In certain embodiments, unicast could be employed in the delivery of the encrypted and unencrypted packets. In other embodiments, the delivery could be via multicast. Shown in FIG. 1a is an exemplary network topology corresponding to a unicast embodiment of the present invention wherein a node 101 is in unicast communication with node 103 via link 105 in accordance with the present invention. Link 105 could be a unidirectional or bidirectional link. Shown in FIG. 1b is an exemplary network topology corresponding to a multicast embodiment of the present invention wherein a node 107 executes multicast transmission via link 111 in accordance with the present invention for receipt by one or more of nodes 109. Included in the exemplary network topology of FIG. 1b are links 113 whereby certain of nodes 109 may dispatch transmissions for reception by node 107. It is noted that the multicast topology of FIG. 1b is also exemplary of broadcast, to which this invention may also be applied.

It is noted wired and/or wireless networks may be employed for packet delivery and reception in accordance with the present invention. Accordingly, Ethernet, 802.11a, 802.11b, 802.11g, DVB-T (Terrestrial Digital Video Broadcast), DVB-C (Cable Digital Video Broadcast), DVB-S (Satellite Digital Video Broadcast), GPRS (General Packet Radio Service), UMTS (Universal Mobile Telecommunications Service), Bluetooth, and/or other networks could be employed.

It is noted that delivery of data flows (encrypted and unencrypted packets) may be on different links, logically and/or physically. As an example, one flow could be over unicast and another over multicast. As a further example, one flow could be over multicast on DVB-T and another over multicast on UMTS.

Various aspects of the present invention will now be described in greater detail.

Packet Delivery

In certain embodiments of the present invention, packet delivery could employ transport mode IPsec (Internet Protocol Security) or the like. More specifically, packets to be transmitted in an unencrypted manner could be dispatched using transport mode IPsec with null encryption, while packets to be transmitted in an encrypted manner could be dispatched using transport mode IPsec with non-null encryption. Alternately, packets to be transmitted in an encrypted manner might be dispatched using transport mode IPsec with non-null encryption, while packets to be transmitted in an unencrypted manner might not employ IPsec.

As will be discussed in greater detail below, in various embodiments of the present invention, for the transmission of a particular data entity all packets dispatched in an encrypted manner may not be decryptable using the same key and/or may not be encrypted using the same algorithm. Thus, for instance, certain of the packets to be dispatched in an encrypted manner could be delivered using DES (Data Encryption Standard) encryption while others could be delivered using 3DES (triple Data Encryption Standard) encryption. Where unicast delivery is being performed, each of the packets could be directed towards a particular unicast IP (Internet Protocol) address. Where multicast delivery is being performed, each of the packets could be directed towards a particular multicast IP address. Alternately or additionally, each dispatched packet could, perhaps in one of its headers, include a data entity transmission identifier corresponding to the data entity transmission with which it is associated and/or an indication of what key should be used to decrypt its payload.

It is further noted that various embodiments of the present invention may employ tunnel mode IPsec or the like in packet delivery. For instance, packets to be transmitted in an unencrypted manner could travel via an unencrypted IPsec tunnel or via an IPsec tunnel employing null encryption, while packets to be transmitted in an encrypted manner could travel via an IPsec tunnel secured via non-null encryption. Alternately, packets to be transmitted in an unencrypted manner might be transmitted in a manner that does not make use of an IPsec tunnel, while packets to be transmitted in an encrypted manner could travel over an IPsec tunnel secured via non-null encryption. As yet another alternative, packets to be transmitted in an unencrypted manner and packets to be transmitted in an encrypted manner could both be transmitted over the same IPsec tunnel, with the packets to be transmitted in an encrypted manner traveling in a flow employing non-null encryption and the packets to be transmitted in an unencrypted manner traveling in a flow employing no encryption or null encryption.

As will be discussed in greater detail below, for various embodiments of the present invention the same tunnel might not be employed for all packets of a data entity dispatched in an encrypted manner. Thus, for instance, certain of the packets of a data entity to be dispatched in an encrypted manner could be delivered via a tunnel employing DES encryption while others could be via a tunnel employing 3DES encryption. Similarly, for various embodiments of the present invention the same tunnel flow might not be employed for all of a data entity's packets that are to be dispatched in an encrypted manner. Accordingly, for example, certain of the packets to be dispatched in an encrypted manner could be delivered via a tunnel flow employing DES encryption while others could be via a tunnel flow employing 3DES encryption.

For embodiments of the present invention that employ tunnel mode IPsec, where unicast delivery is being performed dispatched packets could be directed towards the IP address or the like of the intended recipient. Where multicast delivery is being performed, dispatched packets could be directed towards an appropriate multicast IP address and employed tunnels could have multiple exit points. In certain embodiments, each dispatched packet could as above include, perhaps in a packet header, a data entity transmission identifier.

Some embodiments of the present invention may not employ IPsec transport mode, IPsec tunnel mode, or the like for the delivery of packets to be dispatched in an encrypted manner. Instead, such packets might be delivered using a link that offers its own security. For instance, such packets could be delivered via a DVB-T link that implements a DVB encryption algorithm known in the art. Here too, each dispatched packet could include, perhaps in one of its headers, a data entity transmission identifier.

It is noted that implantation of data entity transmission in the above described embodiments could involve programmatic interface to an appropriate networking stack operating on a sending node. Such a stack could, as appropriate, implement tunnel mode IPsec and/or transport mode IPsec. It is further noted that, in both transport mode IPsec and tunnel mode IPsec, more than one ESP (Encapsulating Security Payload) Security Association (SA) can be defined for a sender. It is further noted that these multiple SA's can be used on the same data link, direction, and/or destination IP address, and that a different encryption algorithm can be defined for each SA. The different SA's can be identified by the value of the Security Parameter Index (SPI) field in the ESP header of each packet. ESP authentication functionality could be used for each SA to provide IP packet source authentication.

Accordingly, for certain embodiments of the present invention, null encryption could be defined for the SA of the path carrying packets to be dispatched in an unencrypted manner, while a non-null encryption algorithm could be defined for the SA of the path carrying packets to be dispatched in an encrypted manner.

Packet Reception

For embodiments of the present invention that employ transport mode IPsec, a recipient node may receive IP packets directed to a unicast or multicast address that it is associated with. The node could be associated with a multicast address by having joined a corresponding multicast group.

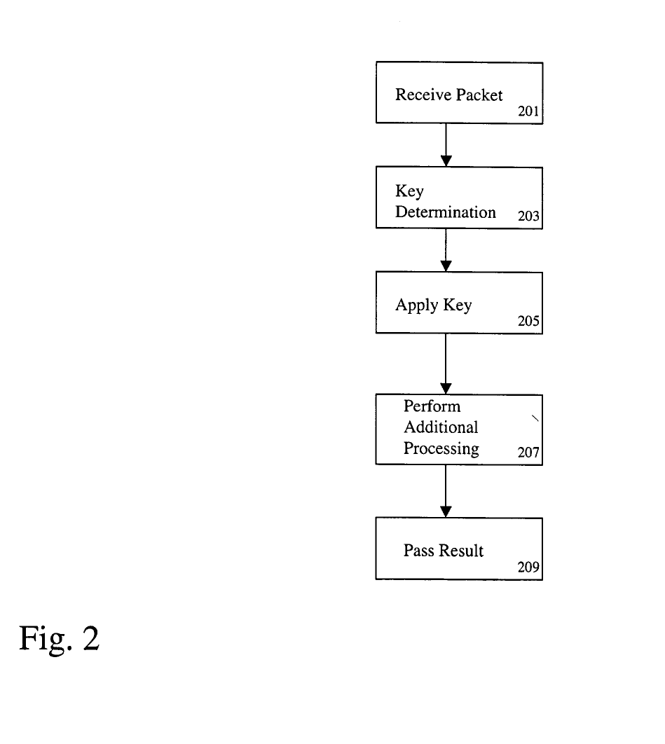

With reference to FIG. 2, it is noted that, in such an embodiment, upon receipt of a packet directed to an IP address with which it is associated (step 201), a node may act to determine what key, if any, needs to be applied in order to access the packet's payload (step 203). This could be achieved, for instance, by analyzing one or more indications contained in one or more of the packet's headers. One analyzed indication could, for instance, be one of the sort noted above that conveys the data entity transmission with which the packet is associated. Another analyzed indication could be one of the sort noted above that conveys which key should be applied to access the packet's payload.

Analysis of the indication could include, for instance, consulting a lookup table correlating such indications with certain keys possessed by the node, The lookup table could be populated, for instance, at the time that the node received keys. Keys and/or lookup table could, for instance, be distributed manually by having the data entered by an employee at a store, kiosk, or the like set up by a media provider and/or service provider. Alternately, keys and/or lookup table data could be distributed over a network in an encrypted manner such that the recipient could perform decryption using a key that the user already possesses. For instance, public key-private key encryption could be used, and the key that the user already possessed could be, for instance, the user's established private key.

The analysis and/or key application could be performed, for example, by networking stack software and/or other software operating on the node. Upon key application (step 205), the networking stack and/or other software could perform additional processing on the packet payload (step 207) and then, for instance, pass the result to application software modules operating on the node (step 209). In some embodiments, the networking stack and/or additional software could act to identify the data entity transmission with which a particular packet was associated. This could involve consideration of a data entity transmission identifier of the sort noted above. In some embodiments, the network stack and/or additional software might not perform any additional processing on the packet payload. Instead, it could pass the packet payload to additional networking stack and/or additional software. This additional networking stack and/or additional software could be responsible for performing further processing on the packet payload and then, for instance, pass the result to application software modules operating on the node.

For received packets which were dispatched via IPsec with null encryption or in an unencrypted manner not using IPsec, the same and/or different networking stack and/or additional software could recognize that no key application was required. Next, the networking stack and/or additional software could, in a manner similar to that just described, perform additional processing on the packet's payload and then, for instance, pass the result to application software modules operating on the node. Alternately, the networking stack and/or additional software could, in a manner similar to that described above, pass the packet payload to other networking stack and/or additional software.

For embodiments of the present invention that employ IPsec tunnel mode, a recipient terminal may receive IP packets directed to a unicast or multicast address that it is associated with. In cases where packets are received via multicast, the receiving node might need to perform a plurality of join operations. For instance, the receiving node might perform a join operation for each tunnel via which packets are received. Similarly, where a terminal is to receive multicasted packets via a plurality of interfaces (e.g., DVB-T or UMTS), the node might perform a join operation for each interface. For embodiments where packets are received both via one or more tunnels and via a manner that does not employ IPsec, the terminal might perform a join operation for each tunnel and for the interface over which packets are received in a manner that does not employ IPsec.

For such embodiments, a receiving terminal, unlike is the case of embodiments where IPsec transport mode is used, might not need to examine individual packets to determine what key, if any, is needed to access packet payload. Instead, each tunnel employed could be relied upon, perhaps via the operation of networking stack and/or additional software operating of the terminal, to present to yield effectively unencrypted packets at the its endpoint. Such could be the case whether a tunnel supplies one flow or a plurality of flows.

In a similar manner, in above-noted embodiments where packets to be dispatched in an encrypted manner are be delivered using a link that offers its own security, such links could be relied upon, perhaps via the operation of a networking stack operating of the terminal, to yield effectively unencrypted packets, the payloads of those packets in decrypted form, data extracted from those packets in decrypted form, and/or the like. The effectively unencrypted packets could be processed by the corresponding networking and/or additional software, and/or passed to other networking stack and/or additional software, in a manner analogous to that discussed above with respect to embodiments of the present invention employing transport mode IPsec.

Although the descriptions refer to the case of two flows (two pluralities of packets), the invention is equally applicable to one or more flows which are constructed from one or more encrypted flows in combination with and zero or more unencrypted flows. Three flows, one of 3DES, one of DES and one unencrypted, is exemplary of this.

Encryption Determination

As alluded to above, various approaches may be taken in determining which of the packets corresponding to the transmission a data entity should be dispatched in an encrypted manner and which of those packets should be dispatched in an unencrypted manner. According to certain embodiments of the present invention, ratios and/or patterns may be applied to stipulate which packets of a data entity will be dispatched in an encrypted manner and which of those will be dispatched in an unencrypted manner. It is noted the same ratio and/or pattern could be applied for the entire transmission of a data entity. Furthermore, in certain embodiments, multiple ratios and/or patterns could be applied to the transmission of a particular data entity. Thus, for example, a first ratio and/or pattern could be applied to the first half of the transmission of a data entity, and a second ratio and/or pattern could be applied to the second half of the transmission.

For example, a pattern could be applied which relied upon a mathematical progression to stipulate which packets should be dispatched in an encrypted manner. Thus, an arithmetic progression pattern could be applied that stipulated that every n^{th} packet (e.g., every 6^{th} packet) be dispatched in an encrypted manner. As yet another example, an extended arithmetic progression pattern could be applied that stipulated that a block of x packets should be dispatched in an encrypted manner every y packets (e.g., a block of 5 packets should be dispatched in an encrypted manner every 75 packets). Patterns based on geometric progressions, or mathematical progressions other than geometric or arithmetic progressions, might also be applied.

As another example, a pattern could be applied which made use of a distribution or modification thereof to stipulate which packets should be dispatched in an encrypted manner. For instance, a Gaussian, pseudo-Gaussian, lognormal, or pseudo-lognormal distribution could be applied. As yet another example, a random pattern could be applied which resulted in a certain ratio of packets being dispatched in an encrypted manner. More generally, it is noted that various other patterns, both arbitrary and meaningful, could be applied to stipulate which packets should be dispatched in an encrypted manner.

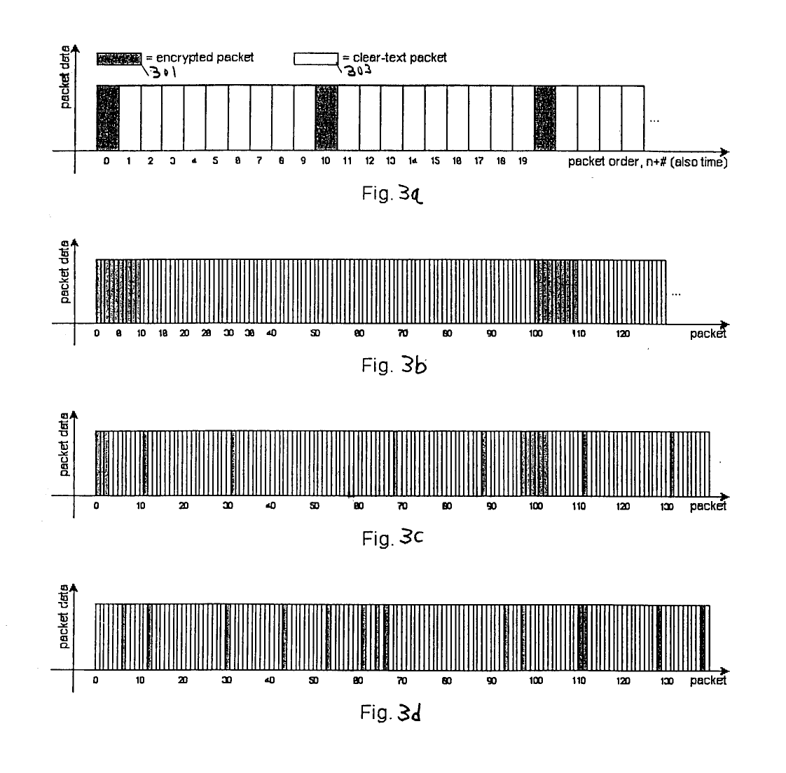

Shown in FIGS. 3a-3d are exemplary patterns for stipulating packets to be dispatched in an encrypted manner. Included in FIGS. 3a-3d are packets to be dispatched in an encrypted manner 301 and packets to be dispatched in an unencrypted manner 303. FIG. 3a shows a pattern based on an arithmetic progression that provides a 9:1 unencrypted packet encrypted packet ratio over 10 packets. FIG. 3b shows a pattern based on an extended arithmetic progression that provides a 9:1 unencrypted packet to encrypted packet ratio over 100 packets. FIG. 3c shows a pseudo-Gaussian pattern that provides a 1:9 encrypted packet to unencrypted packet ratio over 100 packets. FIG. 3d shows a random pattern that provides a 9:1 unencrypted packet to encrypted packet ratio over 100 packets.

In accordance with various embodiments of the present invention, certain factors may be taken into account in establishing ratios, patterns, and/or the like regarding which packets of a data entity should be dispatched in an encrypted manner. For instance, in considering the establishment of a ratio of packets dispatched in an unencrypted manner to number of packets dispatched in an encrypted manner, it might be recognized that increasing the ratio could have the benefit of lowering the amount of decryption processing that needed to be done at a receiving node. As noted above, such could provide benefits such as less power consumption at the receiving node. On the other hand, increasing this ratio could result in the data entity transmission being more prone to receipt by unintended recipients. Accordingly, it might be desirable to choose a ratio that made a compromise between these effects.

For instance, one approach could be to determine the highest ratio that would still provide acceptable prevention of data entity use by unintended recipients. Such a determination could take into account factors such as, for example, the type of data entity, the fee charged to those who wish to receive the data entity legitimately, the ephemerality of the data entity, a confidential nature of the data entity, the particular nature of the data entity, and so on.

For instance, a high unencrypted packet to encrypted packet ratio may be possible for the transmission of software, as a small amount of missing data can render software inoperative. On the other hand a lower ratio might be required for the transmission of stream-type content such as MP3 audio and Realplayer video, as such content may provide a certain level of functionality even when certain of its data is missing even though that level may be perceived as intolerable. For instance, a Realplayer video stream or file missing some data might result only in dropped video frames.

As noted above, factors such as a fee charged, ephemerality, and/or particularities may also be taken into account when deciding upon the ratio to be employed for the transmission of a data entity. Such factors may be useful, for instance, when determining a transmission ratio for data entity types, such as stream type content, where a certain level of functionality can be offered by a transmission even what certain of its data is missing. For instance, suppose a data entity transmission corresponded to a live video feed of a Las Vegas boxing match for which the cost to legitimately receive the data entity transmission was relatively high. For such a data entity transmission, the ratio might need to be set relatively low, with the rationale being that the high price associated with the data entity transmission could result in users being reluctant to pay so long as even a moderately acceptable viewing experience could be had without paying. On the other hand, supposed it were decided that most individuals that wished to listen to transmitted classical music would only do so if the music received was as error-free as possible. Under such circumstances, it might be the case that the ratio could be set relatively high when transmitting a classical music data entity. For the transmission of confidential data entities, the ratio chosen may be the highest possible while still preventing an unintended recipient from being able to discern the nature of the transmitted data entity.

It is noted that certain of the factors just discussed could viewed as being dependent upon user perception. Data according to such perceptions could be collected, for example, via user testing. It is further noted that additional factors beyond those just discussed might also be considered. Such additional factors might, for example, be selected by an expert such as a network expert, media expert, audiologist, psychologist, psychiatrist, or the like. Such additional factors could also be discovered and/or refined via user testing.

Factors could be discovered and/or refined via user testing in a number of ways. For instance, test users could be presented with data entities suffering from various levels of packet loss. The data entities presented could be of various types. For instance, video data entities and music data entities could be presented. Further, specific data entities (e.g., specific films or musical pieces) could be presented. The users could be questioned as to their satisfaction with the data entities. The questions could, perhaps, be presented within certain scenario frameworks. For instance, a user, after being presented with a football game video suffering from missing packets, could be asked how satisfied she would be with the flawed video if the price for legitimate receipt was a specified number of Euros. As another example, a user could be presented with data entities of mock confidential natures, and quizzed on her ability to discern the nature of the data entity.

Certain embodiments of the present invention may employ forward error correction (FEC) in packet delivery. Such FEC may be implemented in a number of ways.

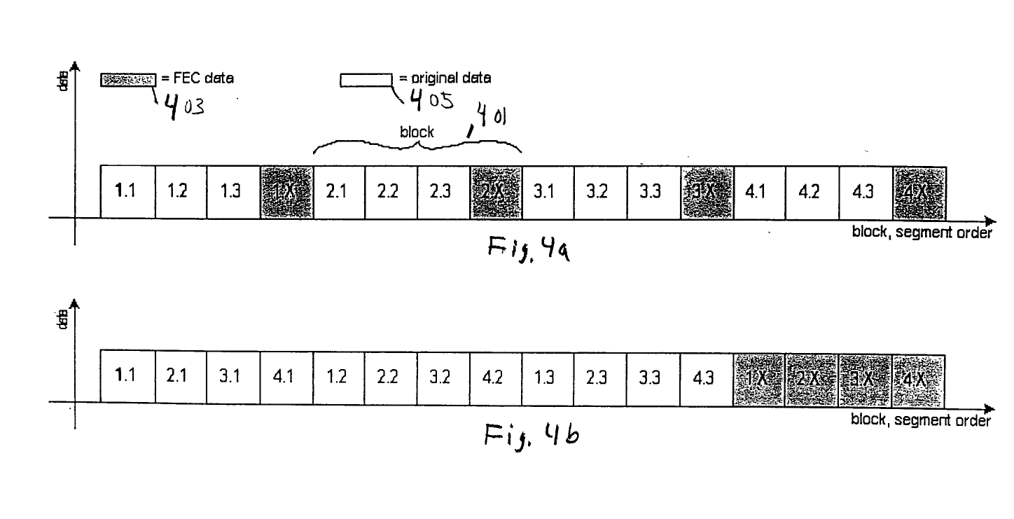

For instance, Open System Interconnect Layer 3 FEC (e.g., IP packet level FEC) may be implemented in a non-interleaved fashion by dividing data to be dispatched into error correction blocks of N consecutive data segments, and inserting M redundant error correction segments within every block. The error correction segments of an error correction block may be calculated based on the data segments in that block. If at least N segments out of the N+M segments in a block are received correctly, then any missing data segments are expected to be reconstructable. On the other hand, a burst error damaging more than M consecutive segments may cause one or more data segments to be lost at the receiver end. An example of such FEC is shown in FIG. 4a. Included in FIG. 4a are error correction blocks 401, error correction segments 403, and data segments 405.

Alternately, Open System Interconnect (OSI) Layer 3 FEC could be implemented in an interleaved fashion by dividing data to be dispatched into error correction blocks of N consecutive data segments and creating M redundant error correction segments for each block. As an example, the segments could then be dispatched in such an order that the data segments corresponding to a certain number of blocks would be dispatched before the error correction segments corresponding to those blocks. In general, FEC will perform better where segments are positioned as far from other segments of the same block as and the order of segments does not generally affect this performance. Thus, the segments of a block that are the closest determine the weakest point in the FEC. An example of such an FEC implementation is shown in FIG. 4b. In FIG. 4b segments are labeled in the form a.b, where a is the ordinal of an error correction block and b is the ordinal of a data segment 405 within the error correction block a. The error correction segment 403 of the error correction block a is identified as a.X.

As is seen in FIG. 4b, first dispatched the first data segments corresponding to each of four error correction blocks. Next dispatched are the second data segments corresponding to each of four error correction blocks, and then the third data segments corresponding to each of four error correction blocks. Then, the error correction segments corresponding to each of four error correction blocks are dispatched. An interleaved FEC implementation is expected to provide better protection against burst error than an non-interleaved implementation, allowing for a burst of up to length total number of segments IN before data loss. Thus, in the example of FIG. 4b, a burst of up four segments could be tolerated without data loss.

For those embodiments of the present invention where FEC is employed, additional factors may need to be taken into consideration in determining an unencrypted packets to encrypted packet transmission ratio. Such may be the case, for instance, for embodiments where FEC operates at OSI Level 3 or higher.

As described above, according to embodiments of the present invention, data is transmitted as a series of packets with certain of the packets being dispatched in an unencrypted manner and certain of the packets being dispatched in an encrypted manner. From the point of view of an unauthorized recipient node, the encrypted packets are effectively lost packets, while the unencrypted packets are effectively properly received packets. As noted above, the use of FEC in data transmission can allow a recipient node to reconstruct the data carried by lost packets, effectively counteracting the loss. Accordingly, in embodiments where FEC is employed, the ratio and/or pattern corresponding to which packets are dispatched in an encrypted manner may need to be selected to prevent FEC from operating at unauthorized receiving nodes to reconstruct data hidden in encrypted packets. Such FEC operation could effectively allow unauthorized recipients to have access to such hidden data.

One approach could be to set the unencrypted packet to encrypted packet ratio high enough that, even with FEC reconstruction operating on an unauthorized recipient node, the user associated with the node would be presented with a data entity that suffered enough from effective packet loss to not be of value to the user. Determination of this ratio could take into account the particular FEC implementation being employed, suggestions by experts such as those of the sort noted above, and/or data garnered from user testing.

Another approach could be to specify that there be consecutive sequences of packets to be dispatched in an encrypted manner with the sequences being of sufficient length to effectively introduce at unauthorized recipient nodes burst error of sufficient length to overwhelm FEC data recovery efforts. For instance, setting sequence length to be total number of segments /N would be expected to cause data loss in the FEC implementations noted above.

Yet another approach to prevent FEC from acting at unauthorized receiving nodes to reconstruct data hidden in encrypted packets could be to overwhelm the errors per correction block limit of the particular FEC scheme being employed. For instance, as noted above, in the FEC schemes described above, any missing data segments are expected to be reconstructable so long as at least N segments out of the N+M segments in a block were received correctly. Accordingly, such FEC schemes could be overwhelmed by configuring packet transmission so that enough packets per error correction block were dispatched in an encrypted manner so as to effectively have unauthorized terminals receive less than N+M segments per block correctly. Thus M+1 or more packers could be dispatched in an encrypted manner per error correction block, resulting in M+1 or more effectively lost segments per error correction block an unauthorized recipients and therefore less than N of N+M data segments in the block being received correctly.

It is noted that, for embodiments where segments span more than a single packet each, it may be sufficient to encrypt a single IP packet within each segment. It is further noted that it may be effective to, where possible, have packets to be dispatched in an encrypted manner be data segments rather than error correction segments, as doing say way result in more data being lost by an unauthorized node. Moreover, it is noted that in certain embodiments, performance of the above-described operations to prevent FEC from operating at unauthorized receiving nodes to reconstruct data hidden in encrypted packets could include monitoring the networking stack software and/or other software implementing FEC at sending nodes so that the operations for preventing data reconstruction at unauthorized nodes could be adjusted to compensate for changes in FEC operation during transmission.

It is noted that the above-described techniques to ensure that FEC does not operate at unauthorized nodes to reconstruct data hidden in encrypted packets may not be necessary in embodiments employing FEC the where FEC operates at OSI Level 2 or lower and the encryption operates at OSI layer 3 or above. Accordingly, it is noted it may be desirable that, if the present invention is to be applied in a network environment employing FEC, it be applied in a network environment employing FEC that operates at OSI Level 2 or lower. Further to this, it is noted that a technique for applying the present invention in a network environment that employs FEC operating at OSI Level 3 or higher may be to alter the network environment to support FEC operating at OSI Level 2 or lower, and to use such an FEC mode in the dispatch of packets in accordance with the present invention. Additionally, it is noted that when practicing the present invention in a network environment where FEC operates at Level 3 or higher, one may choose to configure the network environment so that FEC is not employed in the dispatch of packets in accordance with the present invention. It is noted that FEC performed on data packets after the encryption has been performed will not reduce the security in any case and this may be used in system design to determine the relative OSI layer at which both FEC and encryption are performed.

In certain embodiments of the present invention, packets may be dispatched via a transmission mode, protocol, system, or the like wherein packets are retransmitted via periodic retransmissions and/or in conjunction with an automatic repeat request (ARQ) implementation. For such embodiments, it may be desirable that certain approaches be taken to prevent unauthorized nodes from receiving via such retransmissions data initially effectively lost to them due to the data being carried in packets dispatched in an encrypted manner.

One such approach could be to have all or some retransmitted packets be dispatched in an encrypted manner. In certain embodiments, the encryption employed for such retransmissions could be of a lower level that the encryption employed during original transmissions, perhaps helping to lessen overall decryption burden at authorized recipient nodes. As another approach, all or some of the packets initially dispatched in an encrypted manner could be retransmitted over a different link than the one employed in initial transmission. For instance, in the case where initial transmission involved the use of IPsec over a link that was not inherently encrypted, IPsec might not be employed in retransmission and instead a link offering inherent encryption (e.g., encrypted UMTS) could be used.

Yet another approach could be to have the pattern for dispatching encrypted packets for retransmissions be the same as the pattern employed in initial transmission, so that if a particular packet was initially dispatched in an encrypted manner it would be sent in an encrypted manner in retransmission. It is noted that such an approach may not be applicable for embodiments where it is not known which particular packets were dispatched in an encrypted manner and which particular packets were dispatched in an unencrypted manner. Such might be the case, for example, in embodiments where a certain ratio is applied with regard to which packets should be dispatched in a encrypted manner and which packets should be dispatched in a unencrypted manner, but there is no stipulation and/or notation of which particular packets are dispatched in an encrypted manner and which particular packets are dispatched in an unencrypted manner.

In accordance with certain embodiments of the present invention, various of the techniques described above for specifying which packets of a data entity should be dispatched in an encrypted manner and which packets of that data entity should be dispatched in an unencrypted manner could be applied so that more than one encryption algorithm and/or key is employed in packet dispatch.

For instance, various of the above techniques could be employed such that certain of the packets to be dispatched in an encrypted manner are dispatched using a weaker encryption and others of those packets are dispatched using a stronger encryption. Such an implementation could result in less decryption processing overhead at authorized recipient nodes than if all of the packets to be dispatched in an encrypted manner were dispatching using the stronger encryption. As another example, various of the above techniques could be employed such that certain of the packets to be dispatched in an unencrypted manner are dispatched using a relatively weak encryption algorithm rather than none at all. While such an implementation could result in more decryption processing overhead than if all of the packets to be dispatched in an unencrypted manner were dispatched without the use of non-null encryption, it could result in a more secure transmission. As yet another example, user testing and/or expert advice could be employed in the determination of how more than one encryption algorithm and/or key be employed in packet dispatch. Such user testing and/or expert advice could be similar in nature to the user testing and expert advice described above.

Hardware and Software

Certain devices employed in accordance with the present invention may be implemented using computers. For example, the above-noted nodes may be implemented using network-capable computers. For instance, a receiving node could be a wireless terminal. Furthermore, certain procedures and the like described herein may be executed by or with the help of computers. The phrases “computer”, “general purpose computer”, and the like, as used herein, refer but are not limited to a processor card smart card, a media device, a personal computer, an engineering workstation, a PC, a Macintosh, a PDA, a wired or wireless terminal, a server, a network access point, a network multicast point, or the like, perhaps running an operating system such as OS X, Linux, Darwin, Windows CE, Windows XP, Palm OS, Symbian OS, or the like, perhaps with support for Java or .Net.

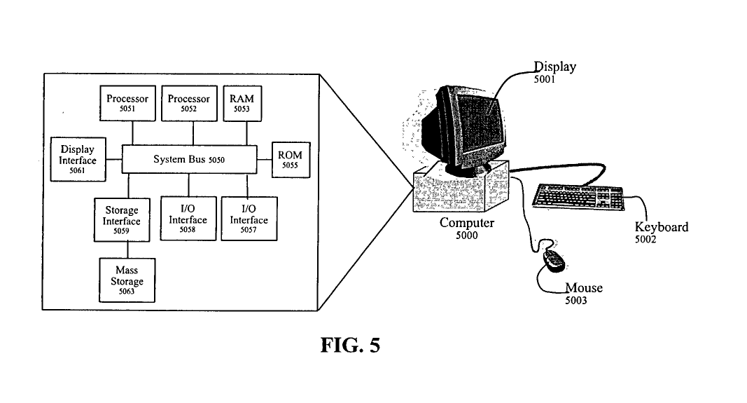

The phrases “general purpose computer”, “computer”, and the like also refer, but are not limited to, one or more processors operatively connected to one or more memory or storage units, wherein the memory or storage may contain data, algorithms, and/or program code, and the processor or processors may execute the program code and/or manipulate the program code, data, and/or algorithms. Accordingly, exemplary computer 5000 as shown in FIG. 5 includes system bus 5050 which operatively connects two processors 5051 and 5052, random access memory (RAM) 5053, read-only memory (ROM) 5055, input output (I/O) interfaces 5057 and 5058, storage interface 5059, and display interface 5061. Storage interface 5059 in turn connects to mass storage 5063. Each of I/O interfaces 5057 and 5058 may be an Ethernet, IEEE 1394, IEEE 802.11b, Bluetooth, DVB-T, DVB-S, digital audio broadcast (DAB), GPRS, UMTS, or other interface known in the art.

Mass storage 5063 may be a hard drive, optical drive, or the like. Processors 5057 and 5058 may each be a commonly known processor such as an IBM or Motorola PowerPC, an AMD Athlon, an AMD Opteron, an Intel ARM, an Intel XScale, a Transmeta Crusoe, or an Intel Pentium. Computer 5000 as shown in this example also includes an display unit 5001, a keyboard 5002 and a mouse 5003. In alternate embodiments, keyboard 5002, and/or mouse 5003 might be replaced with a touch screen, pen, or keypad interface. Computer 5000 may additionally include or be attached to card readers, DVD drives, or floppy disk drives whereby media containing program code may be inserted for the purpose of loading the code onto the computer.

In accordance with the present invention, a computer may run one or more software modules and/or additional software designed to perform one or more of the above-described operations, the modules and/or additional software being programmed using a language such as Java, Objective C, C, C#, or C++ according to methods known in the art. It is noted that any described division of operations among particular software modules and/or additional software is for purposes of illustration, and that alternate divisions of operation may be employed. Accordingly, operations discussed as being performed by one software module and/or additional software item might instead be performed by a plurality of software modules and/or additional software. Similarly, operations discussed as being performed by a plurality of modules and/or additional software might instead be performed by a single module and/or additional software item.

Further, although embodiments of the invention disclose certain software modules and/or additional software as operating on certain devices, in alternate embodiments these modules might be distributed to run on other devices than those stated. For instance, one or more modules disclosed to be running on a sending node might instead run on a receiving node or vice versa. As another example, operations disclosed as being performed by a particular node might instead be performed by a plurality of nodes and/or other devices. It is further noted that, in various embodiments, grid computing techniques may be employed.

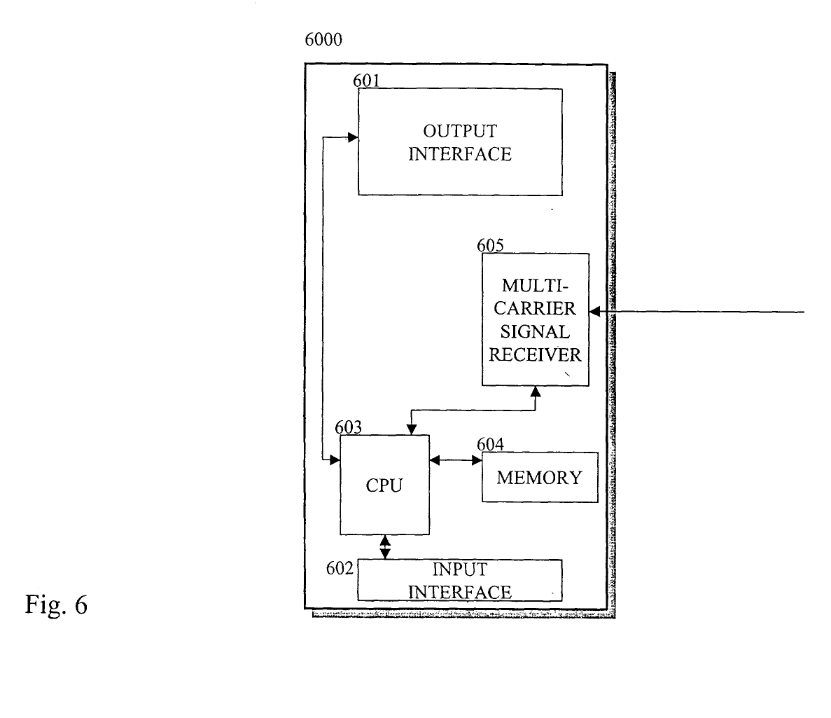

Shown in FIG. 6 is a functional block diagram of an exemplary terminal node employable as a sending or receiving node in various embodiments of the present invention. The terminal node of FIG. 6 has been discussed in the foregoing. In the following, corresponding reference signs have been applied to corresponding parts. Terminal node 6000 of FIG. 6 may be used in any/all of the embodiments described herein. The terminal 6000 comprises a processing unit CPU 603, a multi-carrier signal terminal part 605 and a user interface (601, 602). The multi-carrier signal terminal part 605 and the user interface (601, 602) are coupled with the processing unit CPU 603. The user interface (601, 602) comprises a display and a keyboard to enable a user to use the terminal 6000. In addition, the user interface (601, 602) comprises a microphone and a speaker for receiving and producing audio signals. The user interface (601, 602) may also comprise voice recognition (not shown).

The processing unit CPU 603 comprises a microprocessor (not shown), memory 604 and possibly software. The software can be stored in the memory 604. The microprocessor controls, on the basis of the software, the operation of the terminal 6000, such as the receiving of the data stream, the tolerance of the impulse burst noise in the data reception, displaying output in the user interface and the reading of inputs received from the user interface. The operations are described above. The hardware contains circuitry for detecting the signal, circuitry for demodulation, circuitry for detecting the impulse, circuitry for blanking those samples of the symbol where significant amount of impulse noise is present, circuitry for calculating estimates, and circuitry for performing the corrections of the corrupted data.

Still referring to FIG. 6, alternatively, middleware or software implementation can be applied. The terminal 6000 can be a hand-held device which the user can comfortably carry. Advantageously, the terminal 6000 can be a cellular mobile phone which comprises the multi-carrier signal terminal part 605 for receiving the multicast transmission stream. Therefore, the terminal 6000 may possibly interact with the service providers.

Ramifications and Scope

Although the description above contains many specifics, these are merely provided to illustrate the invention and should not be construed as limitations of the invention's scope. Thus it will be apparent to those skilled in the art that various modifications and variations can be made in the system and processes of the present invention without departing from the spirit or scope of the invention.

What is claimed is:

1. A method for transmitting a data entity, comprising:
transmitting, in an encrypted manner, a first plurality of packets corresponding to said data entity; and
transmitting, in an unencrypted manner, a second plurality of packets corresponding to said data entity.

2. The method of claim 1, wherein transport mode IPsec using non-null encryption is employed in transmitting said first plurality of packets.

3. The method of claim 1, wherein transport mode IPsec using null encryption is employed in transmitting said second plurality of packets.

4. The method of claim 1, wherein an IPsec tunnel employing non-null encryption is employed in transmitting said first plurality of packets.

5. The method of claim 1, wherein an IPsec tunnel employing null encryption is employed in transmitting said second plurality of packets.

6. The method of claim 1, wherein an IPsec tunnel employing no encryption is employed in transmitting said second plurality of packets.

7. The method of claim 1, wherein a first flow of an IPsec tunnel is employed in transmitting said first plurality of packets and a second flow of said tunnel is employed in said second plurality of packets, the first flow utilizing non-null encryption and the second flow utilizing null encryption.

8. The method of claim 1, wherein a first flow of an IPsec tunnel is employed in transmitting said first plurality of packets and a second flow of said tunnel is employed in said second plurality of packets, the first flow utilizing non-null encryption and the second flow utilizing no encryption.

9. The method of claim 1, wherein IPsec is not employed in transmitting said second plurality of packets.

10. The method of claim 1, wherein a secured DVB link is employed in transmitting said first plurality of packets.

11. The method of claim 1, wherein a secured UMTS link is employed in transmitting said first plurality of packets.

12. The method of claim 1, wherein transmission of a first flow is via unicast.

13. The method of claim 1, wherein transmission of a first flow is via multicast.

14. The method of claim 1, wherein transmission of a second flow is via unicast.

15. The method of claim 1, wherein transmission of a second flow is via multicast.

16. The method of claim 1, wherein a first non-null encryption algorithm is employed in transmitting a first portion of said first plurality of packets and a second non-null encryption algorithm is employed in transmitting a second portion of said first plurality of packets.

17. The method of claim 1, wherein a pattern is established to specify packets belonging to said first plurality of packets.

18. The method of claim 1, wherein a ratio is established to specify packets belonging to said first plurality of packets.

19. The method of claim 17, wherein said pattern is pseudo-Gaussian.

20. The method of claim 17, wherein said pattern is based on a mathematical progression.

21. The method of claim 17, wherein forward error correction effects are taken into account in establishing said pattern.

22. The method of claim 17, wherein user testing is employed in establishing said pattern.

23. The method of claim 17, wherein expert advice is employed in establishing said pattern.

24. The method of claim 18, wherein forward error correction effects are taken into account in establishing said ratio.

25. The method of claim 18, wherein user testing is employed in establishing said ratio.

26. The method of claim 18, wherein expert advice is employed in establishing said ratio.

27. A method for receiving a data entity, comprising:
receiving, in an encrypted manner, a first plurality of packets corresponding to said data entity; and
receiving, in an unencrypted manner, a second plurality of packets corresponding to said data entity.

28. The method of claim 27, wherein said first plurality of packets are transmitted via transport mode IPsec using non-null encryption.

29. The method of claim 27, wherein said first plurality of packets are transmitted via transport mode IPsec using null encryption.

30. The method of claim 27, wherein said first plurality of packets are received via an IPsec tunnel employing non-null encryption.

31. The method of claim 27, wherein said second plurality of packets are received via an IPsec tunnel employing null encryption.

32. The method of claim 27, wherein said second plurality of packets are received via an IPsec tunnel employing no encryption.

33. The method of claim 27, wherein said first plurality of packets are received via a first flow of an IPsec tunnel and said second plurality of packets are received via a second flow of said tunnel, the first flow utilizing non-null encryption and the second flow utilizing null encryption.

34. The method of claim 27, wherein said first plurality of packets are received via a first flow of an IPsec tunnel and said second plurality of packets are received via a second flow of said tunnel, the first flow utilizing non-null encryption and the second flow utilizing no encryption.

35. The method of claim 27, wherein IPsec is not employed in the reception of said second plurality of packets.

36. The method of claim 27, wherein said first plurality of packets are received via a secured DVB link.

37. The method of claim 27, said first plurality of packets are received via a secured UMTS link.

38. The method of claim 27, wherein reception of a first flow is via unicast.

39. The method of claim 27, wherein reception of a first flow is via multicast.

40. The method of claim 27, wherein reception of a second flow is via unicast.

41. The method of claim 27, wherein reception of a second flow is via multicast.

42. The method of claim 27, wherein a first portion of said first plurality of packets is subject to encryption of a first non-null encryption algorithm and a second portion of said first plurality of packets is subject to encryption of a second non-null encryption algorithm.

43. The method of claim 27, wherein said first plurality of packets is defined by a pattern.

44. The method of claim 27, wherein said first plurality of packets is defined by a ratio.

45. The method of claim 43, wherein said pattern is pseudo-Gaussian.

46. The method of claim 43, wherein said pattern is based on a mathematical progression.

47. The method of claim 43, wherein said pattern takes into account forward error correction effects.

48. The method of claim 43, wherein said pattern takes into account user testing.

49. The method of claim 43, wherein said pattern takes into account expert advice.

50. The method of claim 44, wherein said ratio takes into account forward error correction effects.

51. The method of claim 44, wherein said ratio takes into account user testing.

52. The method of claim 44, wherein said ratio takes into account expert advice.

53. A system for transmitting a data entity, comprising:
a memory having program code stored therein; and
a processor operatively connected to said memory for carrying out instructions in accordance with said stored program code;
wherein said program code, when executed by said processor, causes said processor to perform the steps of:
transmitting, in an encrypted manner, a first plurality of packets corresponding to said data entity; and
transmitting, in an unencrypted manner, a second plurality of packets corresponding to said data entity.

54. The system of claim 53, wherein transport mode IPsec using non-null encryption is employed in transmitting said first plurality of packets.

55. The system of claim 53, wherein transport mode IPsec using null encryption is employed in transmitting said second plurality of packets.

56. The system of claim 53, wherein an IPsec tunnel employing non-null encryption is employed in transmitting said first plurality of packets.

57. The system of claim 53, wherein an IPsec tunnel employing null encryption is employed in transmitting said second plurality of packets.

58. The system of claim 53, wherein an IPsec tunnel employing no encryption is employed in transmitting said second plurality of packets.

59. The system of claim 53, wherein a first flow of an IPsec tunnel is employed in transmitting said first plurality of packets and a second flow of said tunnel is employed in said second plurality of packets, the first flow utilizing non-null encryption and the second flow utilizing null encryption.

60. The system of claim 53, wherein a first flow of an IPsec tunnel is employed in transmitting said first plurality of packets and a second flow of said tunnel is employed in said second plurality of packets, the first flow utilizing non-null encryption and the second flow utilizing no encryption.

61. The system of claim 53, wherein IPsec is not employed in transmitting said second plurality of packets.

62. The system of claim 53, wherein a secured DVB link is employed in transmitting said first plurality of packets.

63. The system of claim 53, wherein a secured UMTS link is employed in transmitting said first plurality of packets.

64. The system of claim 53, wherein transmission of a first flow is via unicast.

65. The system of claim 53, wherein transmission of a first flow is via multicast.

66. The method of claim 53, wherein transmission of a second flow is via unicast.

67. The method of claim 53, wherein transmission of a second flow is via multicast.

68. The system of claim 53, wherein a first non-null encryption algorithm is employed in transmitting a first portion of said first plurality of packets and a second non-null encryption algorithm is employed in transmitting a second portion of said first plurality of packets.

69. The system of claim 53, wherein a pattern is established to specify packets belonging to said first plurality of packets.

70. The system of claim 53, wherein a ratio is established to specify packets belonging to said first plurality of packets.

71. The system of claim 69, wherein said pattern is pseudo-Gaussian.

72. The system of claim 69, wherein said pattern is based on a mathematical progression.

73. The system of claim 69, wherein forward error correction effects are taken into account in establishing said pattern.

74. The system of claim 69, wherein user testing is employed in establishing said pattern.

75. The system of claim 69, wherein expert advice is employed in establishing said pattern.

76. The system of claim 70, wherein forward error correction effects are taken into account in establishing said ratio.

77. The system of claim 70, wherein user testing is employed in establishing said ratio.

78. The system of claim 70, wherein expert advice is employed in establishing said ratio.

79. A system for receiving a data entity, comprising:
a memory having program code stored therein; and
a processor operatively connected to said memory for carrying out instructions in accordance with said stored program code;
wherein said program code, when executed by said processor, causes said processor to perform the steps of:
receiving, in an encrypted manner, a first plurality of packets corresponding to said data entity; and
receiving, in an unencrypted manner, a second plurality of packets corresponding to said data entity.

80. The system of claim 79, wherein said first plurality of packets are transmitted via transport mode IPsec using non-null encryption.

81. The system of claim 79, wherein said first plurality of packets are transmitted via transport mode IPsec using null encryption.

82. The system of claim 79, wherein said first plurality of packets are received via an IPsec tunnel employing non-null encryption.

83. The system of claim 79, wherein said second plurality of packets are received via an IPsec tunnel employing null encryption.

84. The system of claim 79, wherein said second plurality of packets are received via an IPsec tunnel employing no encryption.

85. The system of claim 79, wherein said first plurality of packets are received via a first flow of an IPsec tunnel and said second plurality of packets are received via a second flow of said tunnel, the first flow utilizing non-null encryption and the second flow utilizing null encryption.

86. The system of claim 79, wherein said first plurality of packets are received via a first flow of an IPsec tunnel and said second plurality of packets are received via a second flow of said tunnel, the first flow utilizing non-null encryption and the second flow utilizing no encryption.

87. The system of claim 79, wherein IPsec is not employed in the reception of said second plurality of packets.

88. The system of claim 79, wherein said first plurality of packets are received via a secured DVB link.

89. The system of claim 79, said first plurality of packets are received via a secured UMTS link.

90. The system of claim 79, wherein reception of a first flow is via unicast.

91. The system of claim 79, wherein reception of a first flow is via multicast.

92. The method of claim 79, wherein reception of a second flow is via unicast.

93. The method of claim 79, wherein reception of a second flow is via multicast.

94. The system of claim 79, wherein a first portion of said first plurality of packets is subject to encryption of a first non-null encryption algorithm and a second portion of said first plurality of packets is subject to encryption of a second non-null encryption algorithm.

95. The system of claim 79, wherein said first plurality of packets is defined by a pattern.

96. The system of claim 79, wherein said first plurality of packets is defined by a ratio.

97. The system of claim 95, wherein said pattern is pseudo-Gaussian.

98. The system of claim 95, wherein said pattern is based on a mathematical progression.

99. The system of claim 95, wherein said pattern takes into account forward error correction effects.

100. The system of claim 95, wherein said pattern takes into account user testing.

101. The system of claim 95, wherein said pattern takes into account expert advice.

102. The system of claim 96, wherein said ratio takes into account forward error correction effects.

103. The system of claim 96, wherein said ratio takes into account user testing.

104. The system of claim 96, wherein said ratio takes into account expert advice.

105. A method for transmitting a data entity, comprising:
transmitting, in an encrypted manner using a first encryption algorithm, a first plurality of packets corresponding to said data entity; and
transmitting, in an encrypted manner using a second encryption algorithm, a second plurality of packets corresponding to said data entity.

106. The method of claim 105, wherein said first encryption algorithm is DES and wherein said second encryption algorithm is 3DES.

107. A method for receiving a data entity, comprising:
receiving, in an encrypted manner using a first encryption algorithm, a first plurality of packets corresponding to said data entity; and
receiving, in an encrypted manner using a second encryption algorithm, a second plurality of packets corresponding to said data entity.

108. The method of claim 107, wherein said first encryption algorithm is DES and wherein said second encryption algorithm is 3DES.

109. A system for transmitting a data entity, comprising:
a memory having program code stored therein; and
a processor operatively connected to said memory for carrying out instructions in accordance with said stored program code;
wherein said program code, when executed by said processor, causes said processor to perform the steps of:
transmitting, in an encrypted manner using a first encryption algorithm, a first plurality of packets corresponding to said data entity; and
transmitting, in an encrypted manner using a second encryption algorithm, a second plurality of packets corresponding to said data entity.

110. The system of claim 109, wherein said first encryption algorithm is DES and wherein said second encryption algorithm is 3DES.

111. A system for receiving a data entity, comprising:
a memory having program code stored therein; and
a processor operatively connected to said memory for carrying out instructions in accordance with said stored program code;
wherein said program code, when executed by said processor, causes said processor to perform the steps of:
receiving, in an encrypted manner using a first encryption algorithm, a first plurality of packets corresponding to said data entity; and
receiving, in an encrypted manner using a second encryption algorithm, a second plurality of packets corresponding to said data entity.

112. The system of claim 111, wherein said first encryption algorithm is DES and wherein said second encryption algorithm is 3DES.

113. A receiving node for receiving a data entity, comprising:
a memory having program code stored therein;
a processor operatively connected to said memory for carrying out instructions in accordance with said stored program code; and
wherein said program code, when executed by said processor, causes said processor to perform the steps of:
analyzing an indication contained in a header of a received packet corresponding to said data entity;
determining if any decryption key is associated with said packet;
selecting a decryption key associated with said indication;
decrypting said packet using the decryption key.

114. The receiving node of claim 113, wherein selecting comprises consulting a lookup table stored at said receiving node, the lookup table pointing to a key stored at the node.

115. The receiving node of claim 114, wherein said lookup table is entered manually to said node.

116. The receiving node of claim 114, wherein said lookup table is distributed over a network in an encrypted manner to said node.

117. The receiving node of claim 114, wherein said decryption key is entered manually to said node.

118. The receiving node of claim 114, wherein said decryption key is distributed over a network in an encrypted manner to said node.

119. The receiving node of claim 113, wherein said node is capable of receiving DVB-T signals.
